(19) United States
(12) Patent Application Publication
(10) Pub. No.: US 2023/0280296 A1
(43) Pub. Date: Sep. 7, 2023

(54) MICRO-BRIDGE DESIGN OF A SENSOR DEVICE

(71) Applicant: TDK CORPORATION, Tokyo (JP)

(72) Inventors: Nishit GOEL, San Jose, CA (US); Stephen BART, West Newton, MA (US); Raitaro MASAOKA, Tokyo (JP); Kazutaka FUJITA, Tokyo, JP (US); Tomokazu ISHIKURA, Tokyo (JP)

(73) Assignee: TDK CORPORATION, Tokyo (JP)

(21) Appl. No.: 18/176,414

(22) Filed: Feb. 28, 2023

Related U.S. Application Data
(60) Provisional application No. 63/268,794, filed on Mar. 2, 2022.
(60) Provisional application No. 63/268,918, filed on Mar. 4, 2022.

(51) Int. Cl. G01N 27/12

(52) U.S. Cl. CPC G01N 27/128

(57) ABSTRACT

A sensor including a micro-bridge structure, wherein the micro-bridge structure comprises a concave geometry, a first electrode on a surface of the micro-bridge structure, a second electrode on the surface of the micro-bridge structure, and a chemical sensing material coupled to the micro-bridge structure overlying the first electrode and the second electrode and exposed to an environment. The chemical sensing material overlays the first electrode and the second electrode and is within the concave geometry of the micro-bridge structure such that the chemical sensing material settles into the concave geometry of the micro-bridge structure during fabrication of the sensor, and wherein the chemical sensing material has an electrical resistance responsive to a concentration of gas in the environment.

### RELATED APPLICATIONS

This application claims priority to and the benefit of co-pending U.S. Patent Provisional Patent Application 63/268,794, filed on Mar. 2, 2022, entitled “DESIGN OF MICROSTRUCTURES FOR RELIABLE PRINTING OF FLUIDIC MATERIALS,” by Goel et al., having Attorney Docket No. IVS-1038-PR, and assigned to the assignee of the present application, which is incorporated herein by reference in its entirety.

This application also claims priority to and the benefit of co-pending U.S. Patent Provisional Patent Application 63/268,918, filed on Mar. 4, 2022, entitled “DESIGN OF MICROSTRUCTURES FOR RELIABLE PRINTING OF FLUIDIC MATERIALS,” by Goel et al., also having Attorney Docket No. IVS-1038-PR, and assigned to the assignee of the present application, which is incorporated herein by reference in its entirety.

### BACKGROUND

Certain gas sensors rely on physical changes or chemical changes in a chemical sensing material while in the presence of a gas to determine concentration of the gas in a surrounding environment. Some gas sensors are microelectromechanical (MEMS) devices including microstructures, such as micro-bridges, upon which gas sensitive inks are printed for use in sensing different gases.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1A is a diagram illustrating a view of an example sensor device including a plurality of micro-bridges, according to some embodiments.

FIGS. 1B through 1D are diagrams illustrating example configurations of electrodes placed on a micro-bridge, according to some embodiments.

FIG. 2 is a diagram illustrating a side view of an example micro-bridge having a concave geometry, according to some embodiments.

FIG. 3 is a diagram illustrating a side view of example printing of a chemical sensing material on a micro-bridge having a concave geometry, according to some embodiments.

FIG. 4 is a diagram illustrating an example surface of a micro-bridge structure comprising micro-dimple structures, according to some embodiments.

FIG. 5 is a diagram illustrating a side view of an example micro-bridge having a convex geometry, according to some embodiments.

FIG. 6 is a diagram illustrating a side view of example printing of multiple chemical sensing materials on a micro-bridge having a convex geometry, according to some embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Overview of Discussion

Discussion includes a description of example micro-bridges designs of a gas sensor, in accordance with various embodiments. Discussion begins with a description of an example sensor including micro-bridges. Discussion continues with a description of a micro-bridge having a concave geometry for receiving a fluidic chemical sensing material. Discussion continues with a description of a micro-bridge having micro-dimples on the surface for receiving a fluidic chemical sensing material. A micro-bridge having a convex geometry for receiving multiple fluidic chemical sensing materials is then described.

By the means of microstructural engineering, embodiments described herein address the issue of printing of fluids on suspended microstructures (e.g., micro-bridges) such that the desired print pattern is achieved. Suspended microstructures, such as micro-bridges, may be curved due to residual stresses present in the structure's layers. By engineering the structure's curvature, fluids can be printed on these suspended structures reliably. This is particularly useful in the field of inks based gas sensing whereby sub-micron sized particles or polymers suspended in a fluidic medium are printed onto suspended structures that acts as a gas sensing material. Conventional suspended microstructures are made such that the curvature is minimized. For example, suspended structures used in the metal oxide based gas sensing field use an edge clamped diaphragm structure that is very low curvature.

The described embodiments provide a suspended microstructure for fluid printing thereon. In some embodiments, curvature of the microstructure can be controlled by microfabrication or heat treatment. In some embodiments, surface roughness of the structure can be controlled by microfabrication or chemical treatment. Other embodiments utilize ink/fluid engineering to provide desired placement of printed fluids. Various embodiments described herein use the curvature of the microstructure as a control method for fluid printing and pattern control. Other embodiments described herein include controlling the surface roughness of the suspended microstructures for reliable printing of fluidic inks. The described embodiments provide improve the reliability of the printed patterns over suspended microstructure through stress engineering and surface roughness control, thus reducing the constraints on the design of suspended microstructures that receive a fluid dispensed over or on the microstructure.

Embodiments described herein provide various techniques for design of micro-bridges for sensor devices to allow for the reliable printing of fluidic chemical sensing materials thereon. In some embodiments, a sensor including a micro-bridge structure comprising a concave geometry, a first electrode on a surface of the micro-bridge structure, a second electrode on the surface of the micro-bridge structure, and a chemical sensing material coupled to the micro-bridge structure overlying the first electrode and the second electrode and exposed to an environment, is described. The chemical sensing material overlays the first electrode and the second electrode and is within the concave geometry of the micro-bridge structure such that the chemical sensing material settles into the concave geometry of the micro-bridge structure during fabrication of the sensor, and wherein the chemical sensing material has an electrical resistance responsive to a concentration of gas in the environment.

In one embodiment, the concave geometry is formed within the micro-bridge structure during the fabrication of the micro-bridge structure. In one embodiment, concave geometry is formed within the micro-bridge structure during the fabrication of the sensor in response to an actuation during deposition of the chemical sensing material. In one embodiment, the actuation comprises an electrical actuation of the micro-bridge structure. In one embodiment, the actuation comprises a heat-based actuation of the micro-bridge structure. In one embodiment, the surface of the micro-bridge structure upon which the chemical sensing material is deposited comprises micro-dimple structures for increasing a surface roughness of the surface.

In other embodiments, a sensor including a micro-bridge structure comprising micro-dimple structures on the surface for increasing a surface roughness of the surface, a first electrode on a surface of the micro-bridge structure, a second electrode on the surface of the micro-bridge structure, and a chemical sensing material coupled to the micro-bridge structure overlying the first electrode and the second electrode and exposed to an environment, is described. The chemical sensing material overlays the first electrode and the second electrode and is deposited over the surface of the micro-bridge structure such that flowing of the chemical sensing material during deposition is impacted by the micro-dimple structures of the micro-bridge structure during fabrication of the sensor, and wherein the chemical sensing material has an electrical resistance responsive to a concentration of a gas in the environment.

In one embodiment, the micro-bridge structure comprises a concave geometry such that the chemical sensing material settles into the concave geometry of the micro-bridge structure during the fabrication of the sensor. In one embodiment, the concave geometry is formed within the micro-bridge structure during the fabrication of the micro-bridge structure. In one embodiment, the concave geometry is formed within the micro-bridge structure during the fabrication of the sensor in response to an actuation during the deposition of the chemical sensing material. In one embodiment, the actuation comprises an electrical actuation of the micro-bridge structure. In one embodiment, the actuation comprises a heat-based actuation of the micro-bridge structure.

In another embodiment, the micro-bridge structure comprises a convex geometry. In one embodiment, the sensor further includes a second chemical sensing material coupled to the micro-bridge structure overlying the first electrode and the second electrode and exposed to an environment, wherein the second chemical sensing material overlays the first electrode and the second electrode and is deposited over the surface of the micro-bridge structure such that flowing of the second chemical sensing material during deposition is impacted by the micro-dimple structures of the micro-bridge structure during fabrication of the sensor, and wherein the second chemical sensing material has an electrical resistance responsive to a concentration of a second gas in the environment. In one embodiment, the convex geometry of the micro-bridge structure prevents contact between the first chemical sensing material and the second chemical sensing material during fabrication of the sensor.

In other embodiments, a sensor including a micro-bridge structure comprising a convex geometry, a first electrode on a surface of the micro-bridge structure, a second electrode on the surface of the micro-bridge structure, a first chemical sensing material coupled to the micro-bridge structure overlying the first electrode and the second electrode and exposed to an environment, and a second chemical sensing material coupled to the micro-bridge structure overlying the first electrode and the second electrode and exposed to an environment, is described.

The first chemical sensing material overlays the first electrode and the second electrode, and has a first electrical resistance responsive to a concentration of a first gas or a class of gases in the environment. The second chemical sensing material overlays the first electrode and the second electrode, and has a second electrical resistance responsive to a concentration of a second gas or a class of gases in the environment. The convex geometry of the micro-bridge structure prevents contact between the first chemical sensing material and the second chemical sensing material during fabrication of the sensor. In one embodiment, the surface of the micro-bridge structure upon which the first chemical sensing material and the second chemical sensing material are deposited comprises micro-dimple structures for increasing a surface roughness of the surface.

### Micro-Bridge Design of a Sensor Device

In accordance with some embodiments, a sensor including a micro-bridge structure comprising a concave geometry is described, such that a printed chemical sensing material is deposited within a recess defined by the concave geometry during fabrication. The concave geometry allows for the controlled deposition or printing of the chemical sensing material, ensuring its appropriate and desired placement on the micro-bridge structure, such that operational performance of the sensor is achieved.

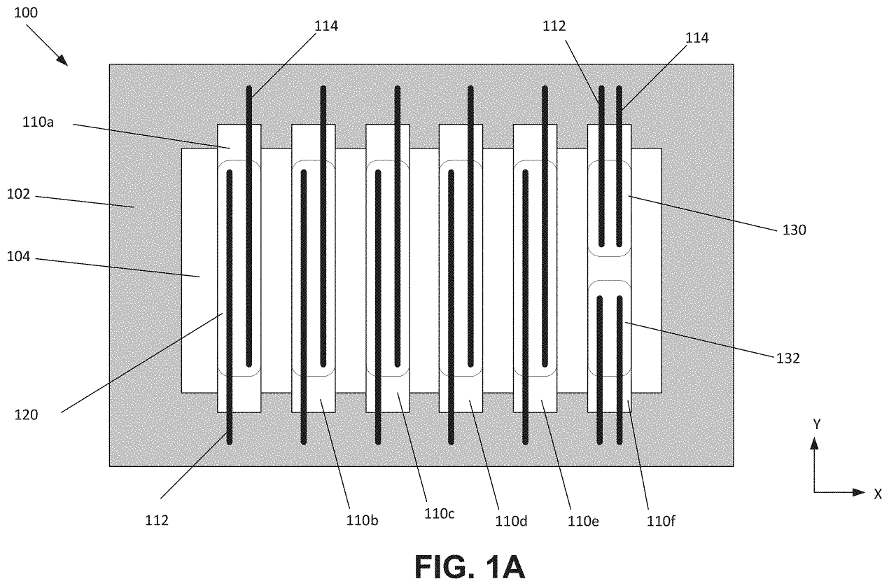

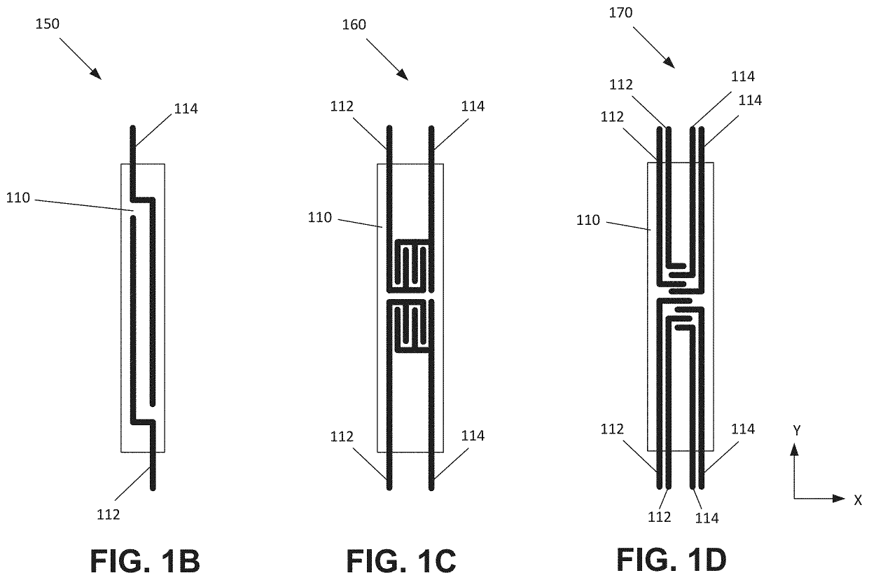

FIG. 1A is a diagram illustrating a view of an example gas sensor device 100 including a plurality of micro-bridges 110, according to some embodiments. Gas sensor device 100 includes a substrate 102 including a cavity 104. As illustrated, gas sensor device 100 includes multiple micro-bridges 110 (illustrated as micro-bridges 110a-110f) upon which one or more chemical sensing materials (e.g., chemical sensing materials 120, 130, and 132) are printed. Gas sensor device 100 also includes multiple electrodes 112 and 114, where each micro-bridge 110 also includes one electrode 112 and one electrode 114.

In some embodiments, substrate 102 of gas sensor device 100 is a CMOS substrate layer, where substrate 102 includes cavity 104. Micro-bridges 110a-110f are deposited or formed on substrate 102. For example, the micro-bridges 110a-110f can be etched to substrate 102 via wet etching or dry etching. Furthermore, the etching of the micro-bridges 110a-110f to substrate 102 can be an isotropic etch or an anisotropic etch (e.g., a deep reactive ion etching, etc.). Cavity 104 can thermally isolate micro-bridges 110a-110f.

Micro-bridges 110a-110f can provide mechanical support for chemical sensing materials 120, 130, and 132 of gas sensor device 100. Chemical sensing materials can be deposited, formed, printed, or otherwise placed on micro-bridges 110a-f over electrodes 112 and 114. Electrodes 112 and 114 can be electrically coupled to a chemical sensing material 120, 130, or 132. Electrodes 112 and 114 can be employed to detect changes in the chemical sensing material. For example, electrodes 112 and 114 can be employed to detect changes in the electrical properties of the chemical sensing material as a concentration of a target gas changes. Electrodes 112 and 114 can be made of a conductive material, such as a noble metal. For example, the electrodes 112 and 114 can comprise titanium nitride, poly-silicon, tungsten, another metal, etc. In one example, electrodes 112 and 114 can be electrically coupled to another component (e.g., an application-specific integrated circuit (ASIC)) of the gas sensor device 100.

FIGS. 1B through 1D are diagrams illustrating example configurations of electrodes placed on a micro-bridge 110, according to some embodiments. In accordance with some embodiments, electrode placement on the surface of a micro-bridge is used to ensure appropriate and desired placement of a chemical sensing material. In such embodiments, electrodes placed on the micro-bridge are extend up from the surface of the micro-bridge, so as to provide a wall or boundary within which to place a chemical sensing material, thereby controlling the placement of the chemical sensing material.

With reference to FIG. 1B, an example electrode configuration 150 of a micro-bridge 110 is shown, according to an embodiment. Electrode configuration 150 is applicable to a micro-bridge having a single chemical sensing material printed thereon, such as micro-bridges 110a-e of FIG. 1A. As illustrated, example electrode configuration 150 includes electrodes 112 and 114, where electrodes 112 and 114 are formed so as to restrict movement in the direction of both the x-axis and the y-axis, effectively assisting in placement of an overlying chemical sensing material by restricting a direction of flow of a printed chemical sensing material.

With reference to FIG. 1C, an example electrode configuration 160 of a micro-bridge 110 is shown, according to an embodiment. Electrode configuration 160 is applicable to a micro-bridge having two chemical sensing materials printed thereon, such as micro-bridge 110f of FIG. 1A. As illustrated, example electrode configuration 160 includes two pairs of electrodes 112 and 114, one for each intended chemical sensing material, where electrodes 112 and 114 are formed so as to restrict movement in the direction of both the x-axis and the y-axis of the chemical sensing materials, effectively assisting in placement of an overlying chemical sensing material by restricting a direction of flow of the printed chemical sensing materials.

With reference to FIG. 1D, an example electrode configuration 170 of a micro-bridge 110 is shown, according to an embodiment. Electrode configuration 170 is applicable to a micro-bridge having two chemical sensing materials printed thereon, such as micro-bridge 110f of FIG. 1A. As illustrated, example electrode configuration 170 includes four pairs of electrodes 112 and 114, each pair for one or more intended chemical sensing materials, where electrodes 112 and 114 are formed so as to restrict movement in the direction of both the x-axis and the y-axis of the chemical sensing materials, effectively assisting in placement of an overlying chemical sensing material by restricting a direction of flow of the printed chemical sensing materials. It should be appreciated that adjacent electrodes 112 and/or 114 can be electrically coupled to effectively perform as a single electrode.

Furthermore, chemical sensing materials can include a metal oxide having an electrical resistance based on a concentration of a gas in an environment surrounding the gas sensor device 100 and/or an operating temperature of the chemical sensing materials. The chemical sensing materials can include an operating temperature greater than room temperature. The chemical sensing materials can include a metal oxide, such as but not limited to, an oxide of chromium, manganese, nickel, copper, tin, indium, tungsten, titanium, vanadium, iron, germanium, niobium, molybdenum, tantalum, lanthanum, cerium or neodymium. Alternatively, the chemical sensing materials can be composite oxides including binary, ternary, quaternary and complex metal oxides. The chemical sensing materials can be employed to detect chemical changes (e.g., chemical changes in response to a gas). For example, a change of electrical resistance of the chemical sensing materials can be employed to detect a gas. In another example, a change of capacitance associated with the chemical sensing materials can be employed to detect a gas. However, it is to be appreciated that other changes associated with the chemical sensing materials (e.g., a change in work function, a change in mass, a change in optical characteristics, a change in reaction energy, etc.) can be additionally or alternatively employed to detect a gas. The chemical sensing materials can be formed through techniques such as printing, sputter deposition, chemical vapor deposition, epitaxial growth and/or another technique.

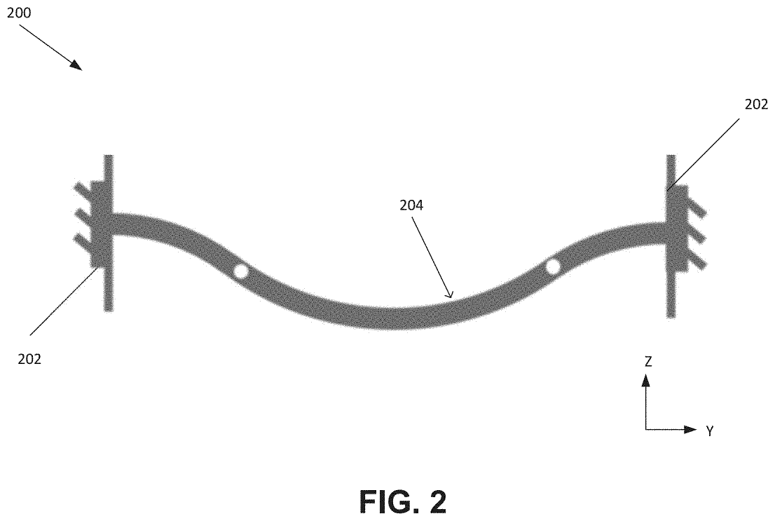

FIG. 2 is a diagram illustrating a side view of an example micro-bridge 200 having a concave geometry, according to some embodiments. In accordance with various embodiments, one or more micro-bridges 110a-f of FIG. 1A can be implemented as micro-bridge 200 having a concave geometry. Micro-bridge 200 is coupled to substrate 202 (e.g., substrate 102 of FIG. 1A) and surface 204 of micro-bridge 200 is overlaid with one or more electrodes (e.g., electrodes 112 and 114 of FIG. 1A; not illustrated). The concave geometry provides for a chemical sensing material deposited onto surface 204 to not flow out of the micro-bridge structure due to gravitational forces for any viscosity of fluids. It should be appreciated that the concave geometry of micro-bridge 200 extends over the X-Y plane of micro-bridge 200, such that a recess or bowl-like shape is formed in micro-bridge 200. A printed chemical sensing material can pool or collect within the concave geometry of micro-bridge 200.

In some embodiments, the curvature of a micro-bridge 200 is controlled, such that the compressive stresses in micro-bridge 200 should be greater than:

$$σ \geq \frac{4 {π}^{2} EI}{A {L}^{2}}$$

### Where:

σ=Compressive stress in micro-bridge 200;

### E=Young's Elastic Modulus;

I=second moment of area of the micro-bridge 200 (function of micro-bridge 200 width and thickness);
A=cross-sectional area of the micro-bridge 200; and
L=length of the micro-bridge 200.

In some embodiments, the compressive stresses in micro-bridge 200 can be generated through intrinsic stresses due to micro-bridge 200 materials when fabricated. In other embodiments, stresses due to thermal expansion or contraction can be induced by heating or cooling micro-bridge 200 (intrinsically or through external sources). In some embodiments, the critical angle of micro-bridge 200 (and thus the residual stress in micro-bridge 200) can be determined by the fluid properties that needs to be printed. For example, the critical angle for a common solvent, ethylene glycol, ranges from 10-25 degrees depending upon the print pattern, surface tension and volume of the pattern printed.

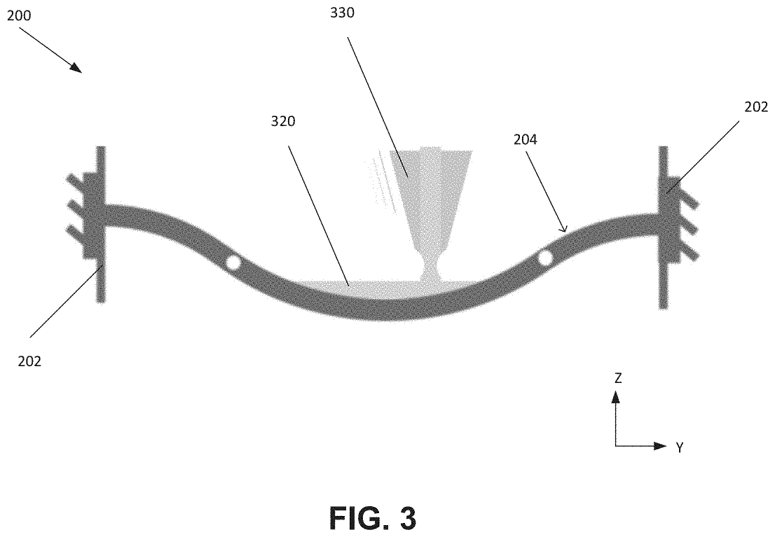

FIG. 3 is a diagram illustrating a side view of example printing of a chemical sensing material 320 on a micro-bridge 200 having a concave geometry, according to some embodiments. It should be appreciated that the concave geometry of micro-bridge 200 extends over the X-Y plane of micro-bridge 200, such that a recess or bowl-like shape is formed in micro-bridge 200. Chemical sensing material 320 is deposited or printed onto micro-bridge 200, collecting within the recess of the concave geometry of micro-bridge 200. In some embodiments, a nozzle 330 is used to print or deposit chemical sensing material 320 onto micro-bridge 200. It should be appreciated that chemical sensing material 320 can be formed through other techniques, such as printing, sputter deposition, chemical vapor deposition, epitaxial growth and/or another technique.

In accordance with various embodiments, chemical sensing material 320 can include a metal oxide having an electrical resistance based on a concentration of a gas in an environment surrounding gas sensor device 100 and/or an operating temperature of chemical sensing material 320. Chemical sensing material 320 can include an operating temperature greater than room temperature. Chemical sensing material 320 can include a metal oxide, such as but not limited to, an oxide of chromium, manganese, nickel, copper, tin, indium, tungsten, titanium, vanadium, iron, germanium, niobium, molybdenum, tantalum, lanthanum, cerium, or neodymium. Alternatively, chemical sensing material 320 can be composite oxides including binary, ternary, quaternary, and complex metal oxides.

In some embodiments, micro-bridge 200 is electrically actuated or heated during deposition of chemical sensing material 320 to form the described concave geometry. Chemical sensing material 320 is heated during deposition to dry up a solvent therein, thereby sticking to the surface of micro-bridge 200 without concern for delamination.

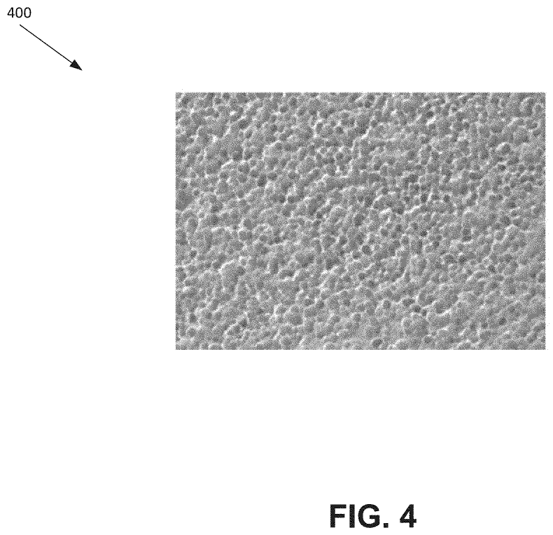

In accordance with some embodiments, a sensor including a micro-bridge structure includes micro-dimple structures on the surface for increasing a surface roughness of the surface is described, such that flowing of a printed chemical sensing material during fabrication is controlled, e.g., as illustrated in FIG. 4. The micro-dimple structures allow for the controlled deposition or printing of the chemical sensing material, ensuring its appropriate and desired placement on the micro-bridge structure, such that operational performance of the sensor is achieved. It should be appreciated that the micro-dimple structures can be implemented with or without the described micro-bridge structure having a concave geometry.

FIG. 4 is a diagram illustrating an example surface of a micro-bridge structure comprising micro-dimple structures 400, according to some embodiments. Micro-dimple structures 400 control roughness of the surface (e.g., surface 204 of FIG. 2) of a micro-bridge (e.g., micro-bridge 200 of FIG. 2). Micro-dimple structures 400 can change or increase the coefficient of friction of the surface of a micro-bridge, thereby controlling the flow of a deposited or printed chemical sensing material. For instance, increasing the coefficient of friction reduces the flow of a chemical sensing material during deposition, thereby allowing the chemical sensing material to stick to the desired location.

In some embodiments, the surface of a micro-bridge is modified during fabrication to add micro-dimple structures 400. For example, the surface of a micro-bridge can be modified using dry etching to add micro-dimple structures 400. The surface roughness can be introduced/generated on the surface of the micro-bridge structure using at least one microfabrication technique such as wet etching, dry etching, lithography techniques, material deposition techniques, etc. Depending upon the roughness of the surface, the wettability of the liquid pattern to be printed can be controlled, such that the rougher the surface, the smaller the wettability. In some embodiments, different models can be used to understand the interaction between the chemical sensing material and the surface roughness such as Wenzel's model and the Cassie-Baxter model.

Increasing the surface roughness by adding micro-dimple structures 400 to the surface of a micro-bridge allows printed fluids (e.g., chemical sensing materials) to bond better with the surface. It should be appreciated that other structures or treatments can be added to the surface of the micro-bridge to increase surface roughness, and that the described embodiments are not limited to micro-dimple structures 400.

With reference to FIGS. 2 and 3, in accordance with some embodiments, surface 204 of micro-bridge 200 includes micro-dimple structures for increasing a surface roughness of surface 204.

In accordance with some embodiments, a sensor including a micro-bridge structure comprising a convex geometry is described, such that two printed chemical sensing materials can deposited thereon without the two printed chemical sensing materials coming in contact. The convex geometry allows for the controlled deposition or printing of the two chemical sensing materials, ensuring their appropriate and desired placement on the micro-bridge structure, such that operational performance of the sensor is achieved.

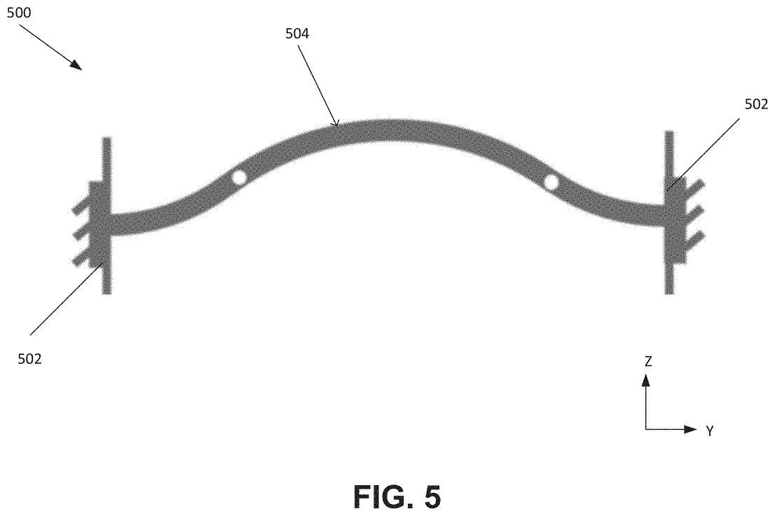

FIG. 5 is a diagram illustrating a side view of an example micro-bridge 500 having a convex geometry, according to some embodiments. In accordance with various embodiments, one or more micro-bridges 110a-f of FIG. 1A can be implemented as micro-bridge 500 having a convex geometry. For example, micro-bridge 110f including chemical sensing materials 130 and 132, can be implemented as micro-bridge 500 having a convex geometry.

Micro-bridge 500 is coupled to substrate 502 (e.g., substrate 102 of FIG. 1A) and surface 504 of micro-bridge 500 is overlaid with one or more electrodes (e.g., electrodes 112 and 114 of FIG. 1A; not illustrated). The convex geometry provides for a chemical sensing material deposited onto surface 504, on either side of the mid-point of micro-bridge 500, to flow to towards substrate 502 on one side of micro-bridge 500 due to gravitational forces for any viscosity of fluids. It should be appreciated that the convex geometry of micro-bridge 500 may extend over the X-Y plane of micro-bridge 500, such that a protrusion is formed in micro-bridge 500. A printed chemical sensing material can flow over surface 504 of micro-bridge 500.

In some embodiments, the compressive stresses in micro-bridge 500 can be generated through intrinsic stresses due to micro-bridge 500 materials when fabricated. In other embodiments, stresses due to thermal expansion or contraction can be induced by heating or cooling micro-bridge 500 (intrinsically or through external sources). In some embodiments, the critical angle of micro-bridge 500 (and thus the residual stress in micro-bridge 500) can be determined by the fluid properties that needs to be printed. For example, the critical angle for a common solvent, ethylene glycol, ranges from 10-25 degrees depending upon the print pattern, surface tension and volume of the pattern printed.

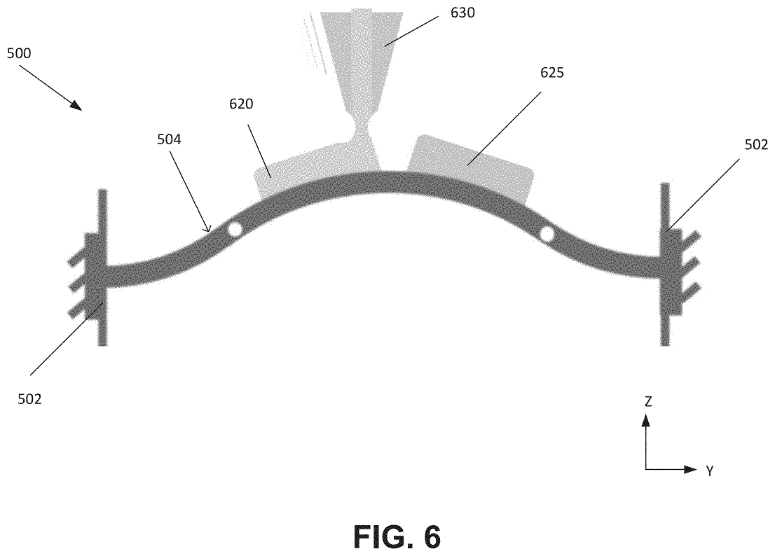

FIG. 6 is a diagram illustrating a side view of example printing of a chemical sensing material 620 on a micro-bridge 500 having a convex geometry, according to some embodiments. It should be appreciated that the convex geometry of micro-bridge 500 extends over the X-Y plane of micro-bridge 500, such that a protrusion may be formed in micro-bridge 500. Chemical sensing materials 620 and 625 are deposited or printed onto micro-bridge 500, to flow to towards substrate 502 on one side of micro-bridge 500 due to gravitational forces for any viscosity of fluids. In some embodiments, a nozzle 630 is used to print or deposit chemical sensing material 620 and/or 625 onto micro-bridge 500. It should be appreciated that chemical sensing materials 620 and 625 can be formed through other techniques, such as printing, sputter deposition, chemical vapor deposition, epitaxial growth and/or another technique.

Chemical sensing materials 620 and 625 are deposited onto different portions of surface 504 of micro-bridge 500 such that chemical sensing materials 620 and 625 do not come in contact with each other. It should be appreciated that more than two chemical sensing materials may be deposited on surface 504 of micro-bridge 500 using different geometries using the techniques described herein, to ensure that the chemical sensing materials do not come in contact with each other.

In accordance with various embodiments, chemical sensing materials 620 and 625 can include a metal oxide having an electrical resistance based on a concentration of a gas in an environment surrounding gas sensor device 100 and/or an operating temperature of chemical sensing materials 620 and 625. Chemical sensing material 620 can include an operating temperature greater than room temperature. Chemical sensing materials 620 and 625 can include a metal oxide, such as but not limited to, an oxide of chromium, manganese, nickel, copper, tin, indium, tungsten, titanium, vanadium, iron, germanium, niobium, molybdenum, tantalum, lanthanum, cerium, or neodymium. Alternatively, chemical sensing materials 620 and 625 can be composite oxides including binary, ternary, quaternary, and complex metal oxides. In some embodiments, chemical sensing materials 620 and 625 are different materials for sensing different chemicals.

In some embodiments, micro-bridge 500 is electrically actuated or heated during deposition of chemical sensing materials 620 and 625 to form the described convex geometry. Chemical sensing materials 620 and 625 are heated during deposition to dry up a solvent therein, thereby sticking to the surface of micro-bridge 500 without concern for delamination.

In accordance with some embodiments, micro-bridge 500 includes micro-dimple structures on surface 504 for increasing a surface roughness of the surface 504 is described, such that flowing of printed chemical sensing materials 620 and 625 during fabrication is controlled. The micro-dimple structure allows for the controlled deposition or printing of the chemical sensing materials 620 and 625, ensuring their appropriate and desired placement on the micro-bridge structure, such that operational performance of the sensor is achieved. It should be appreciated that the micro-dimple structures can be implemented with or without the described micro-bridge structure having a convex geometry.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated examples of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or a particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A sensor comprising:
a micro-bridge structure, wherein the micro-bridge structure comprises a concave geometry;
a first electrode on a surface of the micro-bridge structure;
a second electrode on the surface of the micro-bridge structure; and
a chemical sensing material coupled to the micro-bridge structure overlying the first electrode and the second electrode and exposed to an environment, wherein the chemical sensing material overlays the first electrode and the second electrode and is within the concave geometry of the micro-bridge structure such that the chemical sensing material settles into the concave geometry of the micro-bridge structure during fabrication of the sensor, and wherein the chemical sensing material has an electrical resistance responsive to a concentration of gas in the environment.

2. The sensor of claim 1, wherein the concave geometry is formed within the micro-bridge structure during the fabrication of the micro-bridge structure.

3. The sensor of claim 1, wherein the concave geometry is formed within the micro-bridge structure during the fabrication of the sensor in response to an actuation during deposition of the chemical sensing material.

4. The sensor of claim 3, wherein the actuation comprises an electrical actuation of the micro-bridge structure.

5. The sensor of claim 3, wherein the actuation comprises a heat-based actuation of the micro-bridge structure.

6. The sensor of claim 1, wherein the surface of the micro-bridge structure upon which the chemical sensing material is deposited comprises micro-dimple structures for increasing a surface roughness of the surface.

7. The sensor of claim 1, wherein the first electrode and the second electrode are configured to control flow of the chemical sensing material during the fabrication of the sensor.

8. A sensor comprising:
a micro-bridge structure, wherein a surface of the micro-bridge structure comprises micro-dimple structures for increasing a surface roughness of the surface;
a first electrode on the surface of the micro-bridge structure;
a second electrode on the surface of the micro-bridge structure; and
a chemical sensing material coupled to the micro-bridge structure overlying the first electrode and the second electrode and exposed to an environment, wherein the chemical sensing material overlays the first electrode and the second electrode and is deposited over the surface of the micro-bridge structure such that flowing of the chemical sensing material during deposition is impacted by the micro-dimple structures of the micro-bridge structure during fabrication of the sensor, and wherein the chemical sensing material has an electrical resistance responsive to a concentration of a gas in the environment.

9. The sensor of claim 8, wherein the micro-bridge structure comprises a concave geometry such that the chemical sensing material settles into the concave geometry of the micro-bridge structure during the fabrication of the sensor.

10. The sensor of claim 9, wherein the concave geometry is formed within the micro-bridge structure during the fabrication of the micro-bridge structure.

11. The sensor of claim 9, wherein the concave geometry is formed within the micro-bridge structure during the fabrication of the sensor in response to an actuation during the deposition of the chemical sensing material.

12. The sensor of claim 11, wherein the actuation comprises an electrical actuation of the micro-bridge structure.

13. The sensor of claim 11, wherein the actuation comprises a heat-based actuation of the micro-bridge structure.

14. The sensor of claim 8, wherein the micro-bridge structure comprises a convex geometry.

15. The sensor of claim 8, wherein the first electrode and the second electrode are configured to control flow of the chemical sensing material during the fabrication of the sensor.

16. The sensor of claim 14, further comprising a second chemical sensing material coupled to the micro-bridge structure overlying a third electrode and a fourth electrode and exposed to the environment, wherein the second chemical sensing material overlays the third electrode and the fourth electrode and is deposited over the surface of the micro-bridge structure such that flowing of the second chemical sensing material during deposition is impacted by the micro-dimple structures of the micro-bridge structure during the fabrication of the sensor, and wherein the second chemical sensing material has an electrical resistance responsive to a concentration of a second gas in the environment.

17. The sensor of claim 16, wherein the convex geometry of the micro-bridge structure prevents contact between the chemical sensing material and the second chemical sensing material during the fabrication of the sensor.

18. The sensor of claim 16, wherein the third electrode and the fourth electrode are configured to control flow of the second chemical sensing material during the fabrication of the sensor.

19. A sensor comprising:
a micro-bridge structure, wherein the micro-bridge structure comprises a convex geometry;
a first electrode pair on a surface of the micro-bridge structure;
a second electrode pair on the surface of the micro-bridge structure; and
a first chemical sensing material coupled to a first portion of the micro-bridge structure overlying the first electrode pair and exposed to an environment, wherein the first chemical sensing material overlays the first electrode pair, and wherein the first chemical sensing material has a first electrical resistance responsive to a concentration of a first gas in the environment; and
a second chemical sensing material coupled to a second portion of the micro-bridge structure overlying the second electrode pair and exposed to the environment, wherein the second chemical sensing material overlays the second electrode pair, and wherein the second chemical sensing material has a second electrical resistance responsive to a concentration of a second gas in the environment;
wherein the convex geometry of the micro-bridge structure prevents contact between the first chemical sensing material and the second chemical sensing material during fabrication of the sensor.

20. The sensor of claim 19, wherein the surface of the micro-bridge structure upon which the first chemical sensing material and the second chemical sensing material are deposited comprises micro-dimple structures for increasing a surface roughness of the surface.

21. The sensor of claim 19, wherein the first electrode pair is configured to control flow of the first chemical sensing material during the fabrication of the sensor and the second electrode pair is configured to control flow of the second chemical sensing material during the fabrication of the sensor.
